(19) United States
(12) Patent Application Publication
(10) Pub. No.: US 2025/0073993 A1
(43) Pub. Date: Mar. 6, 2025

(54) METHOD FOR PRODUCING A TEXTILE COMPONENT

(71) Applicant: ON CLOUDS GMBH, CH-8005 ZÜRICH (CH)

(72) Inventors: Johannes VOELCHERT, Zürich (CH); Anna-Maria GEORGARAKIS, Zürich (CH); Damian SCHNEIDER, Zürich (CH); Nils Arne ALTROGGE, Zürich (CH)

(73) Assignee: ON CLOUDS GMBH, CH-8005 ZÜRICH (CH)

(21) Appl. No.: 18/816,422

(22) Filed: Aug. 27, 2024

(30) Foreign Application Priority Data
Aug. 31, 2023 (CH) 000934/2023

(51) Int. Cl. B29C 64/209; B29C 64/118; B29L 31/50; B33Y 10/00; B33Y 80/00

(52) U.S. Cl. CPC B29C 64/209; B29C 64/118; B33Y 10/00; B33Y 80/00; B29K 2995/0097; B29L 2031/505

(57) ABSTRACT

A method for producing a textile material, such as a shoe upper, including providing a shaping carrier, such as a last; providing a plasticizing unit for melting a polymer composition to provide a molten polymer composition; providing a depositing unit with a dosing head which includes at least one nozzle; applying the molten polymer composition via the at least one nozzle on the shaping carrier in a filament forming a plurality of loops on the shaping carrier. The depositing unit and/or the shaping carrier are in a first movement moved relative to each other such that the at least one nozzle moves along a drive path which runs on the shaping carrier. During forming each loop, the dosing head and/or the at least one nozzle is moved in a second movement along a loop depositing path with a path length such that the length of each loop formed on the carrier is larger than the path length of the depositing path.

### CROSS-REFERENCE TO RELATED APPLICATIONS

Swiss Patent Application Nos. CH 000934/2023, filed 31 Aug. 2023, the priority document, corresponding to this invention, to which a foreign priority benefit is claimed under Title 35, United States Code, Section 119, and its entire teachings are incorporated, by reference, into this specification.

### FIELD OF THE DISCLOSURE

The present disclosure relates to the field of producing a textile material, in particular a shoe upper, and relates to a method for producing such a textile material as well as a textile material produced with this method.

### BACKGROUND OF THE DISCLOSURE

Many methods for producing textile materials are known in the prior art. In particular, shoe uppers are typically made from traditionally produced textile materials. Traditionally, textile shoe uppers are for example knitted and then joined to a sole. In known processes, the properties of the knitted textile material may be influenced by the choice made regarding the chosen knitting technique or lapping. In addition, solid shoe uppers, used for example in hard shell shoes, such as ski boots, ice skating boots etc. are typically made in a casting process, e.g. by injection molding, or also by additive manufacturing, respectively 3D printing. The advantage of 3D-printed shoe uppers consists in that the shoe uppers can be adapted individually to the particularities of the wearer's foot, in particular the contour of the foot.

### SUMMARY OF THE DISCLOSURE

While textiles are often associated with woven fabrics, weaving is not the only manufacturing method. Knitting and non-woven are other popular types of fabric manufacturing. In the contemporary world, textiles satisfy the material needs for versatile applications, from simple daily clothing to bulletproof jackets, spacesuits, etc.

Compared with traditional textile engineering production methods, additive manufacturing of the textile material has the advantage that sections of the textile can be constructed differently without significantly greater efforts. For example, a fiber produced by 3D printing may have a larger diameter in some regions than in others, e.g., in order to strengthen certain areas selectively. In contrast, it is not readily possible in traditional production to use a yarn which has a greater diameter in the desired regions of the textile than in other regions. Moreover, with additive manufacturing it is possible to recreate different lapping patterns and mesh widths. Thus, for example, one sub-region of a textile may be configured as a knit, while another sub region is configured as a woven. This is practically not possible with traditional textile production methods. Furthermore, traditional textile production methods are normally associated with significant amounts of cuttings, which is detrimental to the sustainability of such methods.

For shoes with soft textile shoe uppers, in particular those made from fibrous materials, as they are typically used in sports shoes, running shoes and everyday shoes, additive manufacturing nevertheless continues to present several problems. This is mainly because additive production of knitted or woven items often results in the printed fibers being stuck together, and consequently it is not possible to obtain the same properties, particularly in terms of flexibility, as in the traditional textile engineering production methods such as knitting or weaving. Because of the sticking of fibers, the fibers cannot move with respect to each other, which affects the adaptability/flexibility due to shear of the textile. Therefore, 3D printing is not favorable for producing flexible and lightweight textile materials. In addition, 3D printing is rather a slow process and therefore not cost efficient for mass production.

As an alternative to 3D printing, particularly the FDM method, the Melt Blown process is known and used to produce textile materials. However, only nonwovens can be manufactured with the Melt Blown process, it is not possible to produce regularly formed, particularly mesh-like or loop-like textile materials with the Melt Blown process.

One objective of the present disclosure can therefore be seen in proposing a method which allows the creation of a mesh like textile material with various mesh geometries.

The present disclosure relates to a method for producing a textile material, in particular a shoe upper. A textile material includes various fiber-based materials, including fibers, yarns, filaments, threads or also different fabric types. For producing the textile material in the sense of the present disclosure, a shaping carrier is provided. The shaping carrier can be any physical object, as the textile material according to the present disclosure is not restricted to any geometrical constraints. In the context of producing a shoe upper, the shaping carrier is usually a last for a shoe. The last can be a conventional shoe last, made of a polymer composition, metal, wood or the like, as will be described in more detail below noted. The proposed textile material according to the present disclosure is made of a polymer material, typically a polymer composition. Therefore, it can be advantageous if the temperature of the shaping carrier can be controlled. In some embodiments, the shaping carrier includes heating or cooling elements, respectively it is heatable or coolable. Alternatively, the applied material can be melted by an external heat source. One of the advantages of this is that the textile material produced can be materially bonded, in particular welded, directly to another element. In addition, other advantages include, the plasticisation of the polymer can be modified, production cycle time can be influenced and/or polymer layer bonding can be influenced. For example, in some embodiments at least sub-regions of the carrier may be heated after the application of the molten polymer composition to the heatable shaping carrier, and optionally after the applied polymer composition has cooled and hardened, in such manner that an additional component may be welded to the textile material. In the context of shoe production, an insole or a midsole may be welded directly to the shoe upper made of the textile material.

The textile component is typically made from a polymer composition usually comprising a thermoplastic polymer, in particular a polyamide, polyether block amide, polyurethane and/or polyester or a combination thereof. Alternatively, or in addition, an at least partially biodegradable polymer or polymer composition is possible, as well. For conventional 3D printing technologies usually a filament with a diameter in the range between 1.75 mm and 2.85 mm is used. The filament is typically provided in form of a slender plastic thread spooled onto a reel. As the goal of the presented method is to produce a textile material, these conventional methods are unsuitable since the resulting molten filament is too thick and therefore not flexible enough. For the present method typically a filament with a thickness in the range of 0.01 mm to 0.3 mm, in particular from 0.05 mm to 0.2 mm is desired and used. A standard configuration may include a nozzle with a diameter of the outlet, which is between 0.35 mm and 0.4 mm, typically resulting in a diameter of the filament being 0.4 mm to 0.5 mm.

Therefore, a plasticizing unit for melting the polymer composition at a first temperature is provided, to provide a molten polymer composition. The polymer composition may for example be provided in form of granulate or a semi-finished product which is molten by the plasticizing unit. The plasticizing unit typically comprises an extruder and a thereto interconnected dosing head. In some embodiments, the plasticizing unit may include an extruder with a drum, and a screw arranged therein. The plasticizing unit may further have heating elements for setting the first temperature. If an extruder is used, the extruder can build up the pressure with which the polymer composition exits at least one nozzle. Alternatively, a pump or cylinder can be used with which the pressure is build up to exit the polymer composition from an outlet of the at least one nozzle. A pump, in particular a gear pump allows a significantly more precise adjustment and control of the pressure. The pressure exerted by the pump may particularly be between 10 and 80 bar, preferably between 20 and 70 bar, more preferably between 30 and 60 bar, most preferably between 40 and 60 bar.

The person skilled in the art also understands that the selection of the first temperature depends on the melting point, or the melting range of the polymer composition, and it is typically chosen such that the polymer composition is melted and is sufficiently viscous to be applied to the shaping carrier by means of at least one nozzle. The first temperature may also comprise a temperature range. The typical temperature range is thereby between 100 degrees centigrade and 300 degrees centigrade, preferably in a range between 160 degrees centigrade and 260 degrees centigrade. For example, if a thermoplastic polyurethane, such as Desmopan 2790a® or Desmopan 9392A® (Covestro) is used as the polymer composition, the first temperature may have a value for example from 210 to 240° C., in particular 210 to 220° C.

The plasticizing unit may include a plurality of, in particular three, consecutively arranged temperature zones. Each temperature zone may have a separately controllable heating clement. In particular, before it exits the at least one nozzle, the polymer composition may for example pass through a first temperature zone, then a second temperature zone with a temperature that is higher than the temperature of the first temperature zone, and then optionally a third temperature zone with a temperature that is higher than the temperatures of the first and second temperature zones. For example, the first temperature of the first temperature zone may be in a range from 180° C. to 185° C., the second temperature of the second temperature zone may be in a range from 230°° C. to 235° C., and optionally the third temperature of the third temperature zone may be in a range from >235° C. to 240° C.

To be able to apply the molten polymer composition in a controlled manner, a depositing unit is provided, which comprises a dosing head which comprises at least one nozzle. The nozzle may for example have an outlet, e.g. a nozzle outlet. The polymer composition, being molten in the plasticizing unit is typically applied via an outlet of the at least one nozzle on the shaping carrier in form of a filament forming a plurality of loops on the shaping carrier. The outlet may be an opening of the nozzle with a diameter that varies over the course of the outlet. A loop is typically defined as a shape being produced by a curve that bends round and crosses itself or as a closed curve whose initial and final points coincide in a fixed point known as the basepoint. A loop in the sense of the present disclosure is to be understood in a broader sense. Besides essentially circular loops, also oval shaped, snake lines or zigzag patterns are possible. Also loops with an outline following a periodic function, expressed as a superposition of sine wave functions (multimodal decomposition) are possible. Therefore, a loop in the sense of the present disclosure can also have a sinusoidal or sine wave shape. The polymer composition may be applied directly and/or also indirectly to the shaping carrier. The application may be considered as indirect when a plurality of layers of the filament are applied. In this case, it is possible that only a first layer of filament is in direct contact with the shaping carrier.

Typically, only a single filament exits from the outlet of the at least one nozzle, not several filaments at the same time. During the application, the distance between the at least one nozzle and the shaping carrier is typically between 20 mm and 110 mm, in particular between 40 mm to 60 mm.

To create a textile material on the shaping carrier, when applying the molten polymer composition, the depositing unit and/or the shaping carrier may be in a first movement moved relative to each other such that the at least one nozzle moves along a drive path which runs on the shaping carrier. The drive path defines the pattern and structure of the textile material. Typically, the textile is created by laying webs of filament forming loops. Depending on the design or mechanical properties needed, the webs can be laid essentially parallel next to each other, overlapping or crossing and/or forming several superimposed layers.

During forming each loop, the dosing head and/or the at least one nozzle may additionally be moved in a second movement being different from the first movement along a loop depositing path with a path length such that the length of each loop formed on the carrier is larger than the path length of the depositing path. The textile pattern is typically formed by superimposing the primary movement with the secondary movement. The loops are typically either round, preferably circular or oval, or have a regular wave-shape, like a sinusoidal shape. The length of each loop formed on the carrier is to be understood as the length of one loop, e.g., in case of a round loop, the length starting from a cross-over along the loop up to this cross-over, or for example for a circular loop the length of one circle, in case of a sinusoidal loop the length of one period. Alternatively, during forming each loop the shaping carrier may be moved alternatively or additionally to the dosing head and/or the at least one nozzle along the loop depositing path with a path length such that the length of each loop formed on the carrier is larger than the path length of the depositing path.

Due to the movement of the nozzle relative to the dosing head or the dosing head relative to a dosing head holder, the filament is accelerated on its flight path between outlet and shaping carrier. Due to the acceleration of the filament on its flight path between the at least one nozzle and the shaping carrier, the filament is radially deflected which causes the enlarged length of each loop formed on the carrier in relation to the path length of the loop depositing path. The depositing path is typically different from the drive path, in particular wherein a path length of the drive path along which the at least one nozzle moves during the formation of each loop is shorter than the path length of the depositing path during formation of each loop.

In some embodiments, the method is a method for producing a textile material comprising at least the following method steps:
providing a shaping carrier, in particular a last;
providing a plasticizing unit for melting a polymer composition at a first temperature to provide a molten polymer composition;
providing a depositing unit comprising a dosing head which comprises at least one nozzle;
applying the molten polymer composition via the at least one nozzle on the shaping carrier in form of a filament forming a plurality of loops on the shaping carrier; and
during applying the molten polymer composition the depositing unit and/or the shaping carrier may in a first movement be moved relative to each other such that the at least one nozzle moves along a drive path which runs on the shaping carrier and
during forming each loop, the at least one nozzle may additionally be moved relative to the dosing head in a second movement, being different from the first movement along a loop depositing path with a path length such that the length of each loop formed on the carrier is larger than the path length of the depositing path.

Usually, the first movement and the second movement are superimposed. The second movement may comprise moving the at least one nozzle relative to the dosing head. The molten polymer composition typically exits the at least one nozzle through an outlet, typically in form of an opening, forming the filament. During the application the at least one nozzle may be moved relative to the dispensing axis, preferably rotated around the dispensing axis, such that the filament forms loops. The nozzle can be moved within a nozzle housing axially rotatable mounted therein and which is caused to rotate by the plasticized polymer composition flowing through the nozzle housing. The nozzle may extend along an outlet axis, which is aligned at an inclined angle with respect to the dispensing axis.

During the application the shaping carrier may be spaced a distance from the at least one nozzle and the shape of the formed loops corresponds to a movement pattern of the at least one nozzle being defined by the first movement and second movement in an enlarged scale. The person skilled in the art understands that the enlarged shape of such a loop may be described for example by a cone surface, and the path of the filament from the outlet to the shaping carrier may thus be substantially conical. In particular, the shape of the loop may be described by the surface of a cone having an opening angle greater than 5°, particularly greater than 10°, more particularly greater than 15°. The opening angle of the cone may preferably be between 5° and 25°, particularly between 10° and 20°.

The molten polymer composition typically exits the at least one nozzle through the outlet in form of a filament along a dispensing axis. During the application the at least one nozzle may be moved relative to the dispensing axis such that the filament forms loops. Along the dispensing axis is not restricted to only on or along the axis, but also includes rotating or swiveling about the dispensing axis. In case of a rotation around the axis or swiveling with respect to the axis, the molten polymer on its flight path moves with respect to the axis. The dispensing axis typically intersects the shaping carrier and the dosing head. The dispensing axis may be essentially perpendicular with respect to the shaping carrier. Typically, for using the effect of gravity.

In an alternative variation the nozzle can be arranged in a swiveling and rotatable manner, e.g. by a ball joint. An eccentric motion can be achieved by a disk or cantilever arms which are attached to the nozzle and project radially away from the nozzle. The disk or cantilever arms may be moved by at least two actuating elements. Each of the at least two actuating elements is configured to engage one of the cantilever arms or the disk at different actuation points. If the dosing head has only two actuating elements, only a swivel movement of the nozzle and therefore of the applied material (e.g. the molten polymer composition) is possible. It is therefore preferred that the dosing head has at least three actuating elements, ideally an even greater number, to enable the most precise possible movement of the outlet of the nozzle, approximating a circular path. It is preferred that both the actuating elements and the application points are arranged at constant angular distances from each other with respect to a longitudinal axis of the nozzle, so that a high degree of symmetry is provided.

Due to the filament exiting the outlet of the nozzle, forming loops, the textile material typically comprises regular filament segments which intersect each other at crossover positions and form circular coils. Due to the circular motion of the nozzle and/or the dosing head, the resulting loops are essentially circular as well. This variation has the advantage that the eccentricity of the outlet of the nozzle can be changed continuously and quickly with the appropriate design and control of the dosing head leading to loops with a varying diameter. In addition, the application is not necessarily circular, but can assume other shapes by appropriate control of the dosing head. The dosing head can be kept still regarding the longitudinal axis so that the material can be applied in a relatively thin, straight line.

Typically, the filament is continuous and moves freely between the outlet and the shaping carrier on a flight path. During the application of the polymer composition, the at least one nozzle is typically moved relative to the dispensing axis and/or the shaping carrier is moved relative to the at least one nozzle such that the filament forms loops on the shaping carrier. The movement of the shaping carrier and/or the dosing head with the at least one nozzle can be controlled by a control unit. As a consequence, a loop-like textile material comprising the polymer composition forms on the shaping carrier. In this context, a loop-like textile material may comprise a plurality of intersecting, but preferably not entangling, coils or loops.

In some embodiments, the method is a method for producing a textile material comprising at least the following method steps:
providing a shaping carrier, in particular a last;
providing a plasticizing unit for melting a polymer composition at a first temperature to provide a molten polymer composition;
providing a depositing unit comprising a dosing head which comprises at least one nozzle;
applying the molten polymer composition via the at least one nozzle on the shaping carrier in form of a filament forming a plurality of loops on the shaping carrier; and
during applying the molten polymer composition the depositing unit and/or the shaping carrier may in a first movement be moved relative to each other such that the at least one nozzle moves along a drive path which runs on the shaping carrier and
during forming each loop, the dosing head and the at least one nozzle may additionally be moved in a second movement, being different from the first movement along a loop depositing path with a path length such that the length of each loop formed on the carrier is larger than the path length of the depositing path.

In the second movement, the at least one nozzle and/or the dosing head and the at least one nozzle can be moved in a round, preferably circular or oval, and/or an eccentric and/or a pendulum movement. This allows the creation of irregular and non-circular patterns. The dosing head may be interconnected to an eccentric rod which is interconnected to an eccentric to create a lateral back and forth movement along a longitudinal axis. With the eccentric a rotational movement can be converted into a translational movements and vice versa. With the eccentric the at least one nozzle and/or the shaping carrier can be moved back and forth.

In some embodiments, the method is a method for producing a textile material comprising at least the following method steps:
providing a shaping carrier, in particular a last;
providing a plasticizing unit for melting a polymer composition at a first temperature to provide a molten polymer composition;
providing a depositing unit comprising a dosing head which comprises at least one nozzle;
applying the molten polymer composition via the at least one nozzle on the shaping carrier in form of a filament forming a plurality of loops on the shaping carrier; and
during applying the molten polymer composition the depositing unit and/or the shaping carrier may in a first movement be moved relative to each other such that the at least one nozzle moves along a drive path which runs on the shaping carrier and
during forming each loop, the dosing head and the at least one nozzle may be moved together relative to the dosing head holder. in a second movement being different from the first movement along a loop depositing path with a path length such that the length of each loop formed on the carrier is larger than the path length of the depositing path.

Compared with a non-woven, the shoe upper therefore has one or more regularly arranged filaments. If the at least one nozzle is moved relative to the dispensing axis, the filament exits the at least one nozzle and is, caused by the relative movement of the at least one nozzle, along the flight path between the at least one nozzle and shaping carrier accelerated. When the at least one nozzle revolves on a circular path around the dispensing axis, the resulting centrifugal force accelerates the filament radially away from the circular path of the at least one nozzle. The depositing unit may comprise a dosing head holder to which the dosing head is connected and wherein the second movement comprises moving the dosing head and the at least one nozzle together relative to the dosing head holder.

The molten polymer composition can exit the at least one nozzle through the outlet forming the filament and during the application the dosing head and the at least one nozzle are together moved relative to the dosing head holder about the dispensing axis such that the filament forms loops. The at least one nozzle may be tilted with respect to the dosing head about an angle. In some embodiments, the angle between the dispensing axis and the outlet and the discharge direction may be between 40° and 60°, preferably between 50° and 60°, in particular 55°. The at least one nozzle may be dynamically pivoted about an axis with respect to the dispensing axis. In addition, the shaping carrier can be moved along at least one degree of freedom about an axis. This movement allows to create loops with a more complex geometry. For example, loops essentially shaped like the infinity symbol are possible with a tumbling nozzle.

By preselecting the motion pattern of the at least one nozzle with respect to the dispensing axis, the properties of the produced textile material may then be varied and adjusted selectively and at any predefined point in time. For example, a very small radius creates a region in the textile material with very tight loops or coils, and consequently to lower elasticity and higher stability, such as is needed for example in areas that are exposed to high mechanical loads. Selection of a larger radius of the helical filament creates a region in the textile material with larger loops or coils, which results in greater elasticity in this region. In particular, the radius of the filament may increase from the outlet towards the shaping carrier, preferably constantly.

An advantage of the present method is to be able to produce a textile material, particularly a shoe upper, within a much shorter process time. The shaping carrier can be moved relative to the dosing head and the at least one nozzle at a speed of 1 m/min to 20 m/min, in particular 5 m/min to 15 m/min. For example, in this way it is possible to produce an entire shoe upper in only 1 minute to 5 minutes, typically in about 3 minutes. Amongst others, because of this very short process time, it is therefore possible to significantly reduce the energy consumption per unit of textile material produced, in particular per shoe upper. In particular, just 0.035 to 0.06 kWh is required to produce a shoe upper. For the purpose of the present disclosure, a shoe upper refers to a shoe upper which is configured as a textile, and is therefore of softer, more flexible construction as compared to a hard shell shoe upper. Shoe uppers of such kind constructed from a textile are known for example from sports shoes such as tennis or running shoes.

The filament is typically applied at least intermittently, or also entirely, as a continuous filament. The polymer composition is typically applied as a continuous filament to the shaping carrier so as to form a textile segment. Depending on the product to be produced, the polymer composition can alternatively or in addition be applied as a discontinuous filament so as to form a nonwoven-like textile segment. The textile material produced then comprises a plurality of continuous loops or coils which consist of a single, continuous filament. Thus, such a textile material is not a non-woven. After a predetermined number of coils or loops have been applied, the application and therewith also the filament may be interrupted, and resumed at a different position on the shaping carrier. In addition, the area to be covered or the length of the material layer may be pre-determined. In some embodiments, the shaping carrier, in particular the last, may include one or more depressions, in particular grooves or furrows. To produce a discontinuous filament, air exit openings can be arranged around the outlet of the at least one nozzle. With an air blast of pressurized air, the filament can be divided on its flight path into discontinuous segments. In addition, discontinuous fibres can be generated by stopping the polymer extrusion of by abrupt motion of the nozzle.

For the production of a shoe upper or even an entire shoe, the shaping carrier may be a last as previously stated. The last may be produced in a first step on the basis of a 3D model of the wearer's foot. For this, a wearer's foot may be measured, and a 3D model thereof created on the basis thereof. This results in the production of an individual shoe upper adapted to the foot of the wearer. In alternative embodiments, the shaping carrier may be a model of a textile product, like a bag, a backpack etc. The shaping carrier may also be a plate for producing an essentially two-dimensional textile product. The shaping carrier may be heatable such that the textile material produced can be materially bonded, in particular welded, directly to another element.

Alternatively, the welding might be performed by an external heat source, e.g. hot air or radiation. The shaping carrier may be coolable to reduce the cycle time by fastening the demolding process. In some embodiments at least sub regions of the carrier may be heated after the application of the molten polymer composition to the heatable shaping carrier, and optionally after the applied polymer composition has cooled and hardened, in such manner that an insole or a midsole may be welded directly to the shoe upper. The fabricated textile material is a shoe upper and is bonded to a sole, or wherein the shoe upper is bonded directly to a sole during application.

In some embodiments, the shaping carrier, in particular the last, may include one or more depressions, in particular grooves or furrows. In this way, it may be possible for additional elements such as textile material, foam material, cushioning material, metal or plastic material to be inserted in the depressions before the molten polymer composition is applied to the shaping carrier. When the molten polymer composition is applied, a material bond is created between the polymer composition and the additional elements. For example, the shaping carrier may be a last, which has one or more depressions in the heel region. An impact-absorbing material may be dispensed in these depressions, and arranged in such manner that the heel region of the shoe upper is configured to absorb impacts, or that a heel cushion (also called “heel padding”) is formed. Alternatively, it is also possible that no additional elements are inserted in the depression(s), but they are instead completely filled with the polymer composition when the molten polymer composition is applied. This has the effect of strengthening the textile material in predefined regions of the textile material.

In some embodiments, the polymer composition may have an adjustable second temperature during the application, particularly upon contact with the shaping carrier. The second temperature is typically influenced after the filament has exited the nozzle, e.g. by defining the length of the flight path between outlet and shaping carrier and/or by actively influencing the temperature by heating or cooling, e.g. with hot or cold air or radiation. The second temperature may either be selected such that the filament applied to the shaping carrier does not bond at crossover positions of filament segments or is selected such that the filament applied to the shaping carrier bonds at crossover positions of filament segments, in particular by fusion.

Filament segments that are not materially bonded are typically able to move relatively freely and independently with respect to each other. In this way, an advantageous flexibility on the production of the textile material is achieved. A material bond of the loops of the polymer composition applied to the shaping carrier may be created at a predetermined region at any predetermined point in time. The greater the proportion of materially bonded intersecting positions, the less flexible or stretchable a certain region of the produced textile material, in particular of the shoe upper, and accordingly the greater the stability and strength of this region. This can be especially advantageous in regions of the textile material that are subjected to strong mechanical stress, such as the top side of the forefoot region of a shoe upper, which is folded, compressed and stretched during the rollover process.

A lower proportion of materially bonded intersecting positions correspondingly increases the flexibility, and stretchability, of the corresponding region of the shoe upper, for example is advantageous in regions of the shoe which are stretched intensively during running motion because of the anatomical movements. In this context, the second temperature may be selected such that it is lower than the melting temperature, or the melting temperature range by a predefined value, so that material bonding of the filament segments does not occur. If it is intended that material bonding should take place, then the second temperature is selected such that it is substantially at least equal to the melting temperature, or the melting temperature range of the polymer composition, or such that it is only a suitable amount below the melting temperature. In some embodiments, the second temperature may be set by means of an airflow with predetermined temperature impinging on the polymer composition. The airflow may be supplied from an air discharge apparatus arranged in the region between the outlet of the at least one nozzle and the shaping carrier. Thus, for example, an air discharge apparatus with air nozzles, from which the airflow is discharged at a predetermined temperature in the direction of the filament may be disposed along the filament after it has exited the outlet.

A further aspect of the invention relates to an article of apparel, in particular a shoe, comprising a textile material, in particular a shoe upper, produced with a method according to any of the embodiments disclosed herein. Such an article of apparel, in particular a shoe upper, includes a loop-like textile material. This may have a plurality of substantially regularly constructed coils. A plurality of coils, respectively loops, are preferably made from a single filament. Filament segments may cross each other at intersecting positions. The filament segments may be materially bonded to each other and/or not materially bonded to each other at the intersecting positions. The loop-like textile material preferably comprises at least one intersecting position at which filament segments, in particular filament segments of the same filament, are materially bonded. The coils, respectively loops, are preferably substantially circular or elliptical in shape. A shoe upper which has been produced according to a method of one of the embodiments disclosed here does not typically form a continuous surface, instead it is mesh-like, that is to say it has a certain porosity and permeability.

A further aspect is a discharge apparatus for carrying out the method according to one of the embodiments disclosed herein. The discharge apparatus comprises a dosing head which is in fluid communication with a plasticizing unit and with a separate dosing pump. The plasticizing unit comprises an extruder, which typically has a drum, and a screw arranged therein. The discharge apparatus further includes a separate dosing pump, which is in fluid communication with the dosing head. The dosing head has at least one nozzle comprising an outlet which is in fluid communication with the dosing head. The discharge apparatus can furthermore comprise a shaping carrier, preferably in form of a last for a shoe as described above noted in more detail. The extruder has the advantage that the polymer composition is freshly melted directly in the required quantity in each case, and is not kept constantly in a molten state in a plasticizing unit such as a heatable tank or the like. If the polymer composition is kept in the molten state for a prolonged period, the quality of the polymer deteriorates substantially, as the polymer composition is partly degenerated. Quality, particularly the stability of the filament, is very important in the production of the textile material. The combination of the dosing head with an extruder allows to only melt the quantity of polymer composition that is required at the time, thereby avoiding degeneration of the polymer composition and the associated loss of stability.

In this context, the plasticizing unit may include a plurality of, in particular three, consecutively arranged temperature zones. Each temperature zone may include a separately controllable heating element. In particular, for example, before it exits the at least one nozzle the polymer composition may pass through a first temperature zone, then a second temperature zone with a temperature that is higher than the temperature of the first temperature zone, and then optionally a third temperature zone with a temperature that is higher than the temperatures of the first and second temperature zones. For example, the first temperature of the first temperature zone may be in a range from 180° C. to 185° C., the second temperature of the second temperature zone may be in a range from 230° C. to 235° C., and optionally the third temperature of the third temperature zone may be in a range from >235° C. to 240° C.

The dosing pump is a pump that is separate from the extruder. It would be possible for the polymer composition to be discharged from the outlet onto a shaping carrier with the aid of the extruder alone, but it is important for the production of a textile material which has a mesh-like construction and comprises a single filament over a plurality of mesh structures and coils, that the discharge pressure can be precisely controlled, which is not possible to a sufficient degree with an extruder. The separate pump therefore serves to fine-tune the pressure with which the molten polymer composition is discharged. The dosing pump is preferably a gear pump. The discharge apparatus may further include a motor for driving the dosing pump. In further embodiments, the discharge apparatus further comprises an air discharge apparatus, which is configured to impinge an airflow at predetermined temperature on the filament which is in helical form after exiting the outlet of the at least one nozzle for setting the second temperature of the exited polymer composition.

It is to be understood that both the foregoing general description and the following detailed description present embodiments and are intended to provide an overview or framework for understanding the nature and character of the disclosure. The accompanying drawings are included to provide a further understanding and are incorporated into and constitute a part of this specification. The drawings illustrate various embodiments, and together with the description explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings which should not be considered limiting to the disclosure described in the appended claims.

FIG. 1 shows a perspective view from the front and above on a schematic illustration of a first variation of the discharge apparatus;

FIG. 2 shows a schematic illustration of the textile material made by the discharge apparatus shown by FIG. 1;

FIG. 3 shows a perspective view from the front and above on a schematic illustration of a first variation of the dosing head;

FIG. 4 shows a top view on the dosing head according to FIG. 3;

FIG. 5 shows a perspective view from the front and above on a schematic illustration of a second variation of the dosing head;

FIG. 6 shows a top view on the dosing head according to FIG. 5;

FIG. 7 shows a perspective view from the front and above on a schematic illustration of a third variation of the dosing head;

FIG. 8 shows a sectional view on the dosing head according to FIG. 7;

FIG. 9 shows a schematic illustration of a textile material made by a dosing head shown by any of FIGS. 3 to 8;

FIG. 10 shows a perspective view from the front and above on a schematic illustration of a second variation of the discharge apparatus with a swiveling dosing head;

FIG. 11 shows a perspective view from the back on a schematic illustration of the discharge apparatus according to FIG. 10 in three positions;

FIG. 12 shows a perspective view from the front and above on a schematic illustration of a fourth variation of the dosing head with an eccentric drive;

FIG. 13 shows a top view on the dosing head according to FIG. 12;

FIG. 14 shows a schematic illustration of a textile material made by a dosing head shown by FIGS. 10 and 11 or the dosing head shown by FIGS. 12 and 13;

FIG. 15 shows a first lateral view on a schematic illustration of a fifth variation of the dosing head with a swiveling nozzle;

FIG. 16 shows a second lateral view on a schematic illustration of a fifth variation of the dosing head with a swiveling nozzle; and

FIG. 17 shows a schematic illustration of a textile material made by a dosing head shown by FIGS. 15 and 16.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

FIG. 1 shows a perspective view from the front and above on a schematic illustration of a first variation of the discharge apparatus 13. The shown discharge apparatus 13 comprises a dosing head 5, which is in fluid communication with a plasticizing unit 3 and with a separate dosing pump 14. The plasticizing unit 3 comprises an extruder 15, which typically has a drum 16, and a screw (not shown) arranged therein. The dosing pump 14 is in fluid communication with the dosing head 5. The dosing head 5 has at least one nozzle 6 comprising an outlet 9, which is in fluid communication with the dosing head 5. The shown dosing head 5 is interconnected to the depositing unit by a dosing head holder 17. The dosing head holder 17 connects the dosing head 5 to the depositing unit 4 in a movable manner. The shown plasticizing unit 3 includes a plurality of, in particular three, consecutively arranged temperature zones. Each temperature zone includes a separately controllable heating element.

The polymer composition passes through a first temperature zone, then a second temperature zone with a temperature that is higher than the temperature of the first temperature zone, and then optionally a third temperature zone with a temperature that is higher than the temperatures of the first and second temperature zones. For example, the first temperature of the first temperature zone may be in a range from 180° C. to 185° C., the second temperature of the second temperature zone may be in a range from 230° C. to 235° C., and optionally the third temperature of the third temperature zone may be in a range from >235° C. to 240° C.

The dosing pump 14 is a pump that is separate from the extruder 15. It would be possible for the polymer composition to be discharged from the outlet 9 onto the shaping carrier 2 with the aid of the extruder 15 alone, but it is important for the production of the textile material 1 which has a mesh-like construction and comprises a single filament 7 over a plurality of mesh structures and loops 8, that the discharge pressure can be precisely controlled, which is not possible to a sufficient degree with the extruder 15. The separate pump therefore serves to fine-tune the pressure with which the molten polymer composition is discharged. The dosing pump 14 is preferably a gear pump. The discharge apparatus 13 may further include a motor for driving the dosing pump 14.

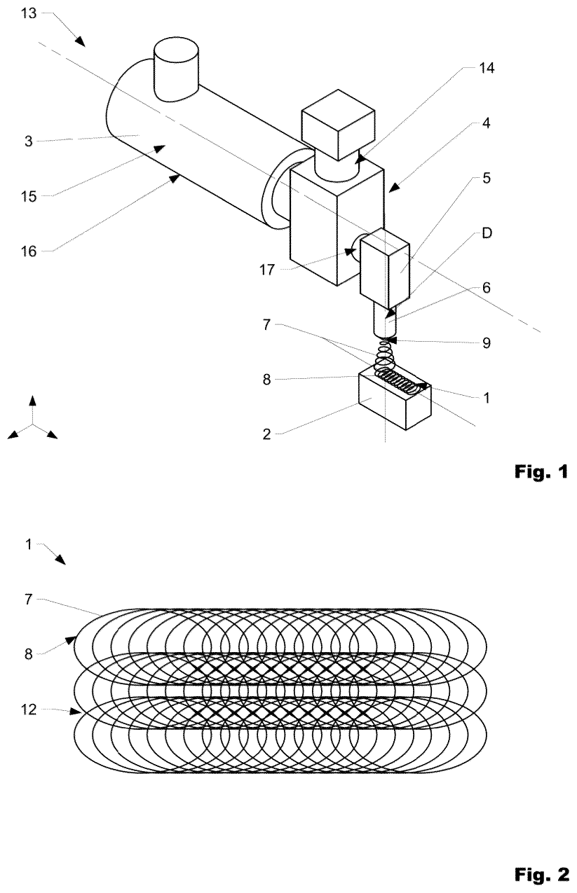

FIG. 2 shows a schematic illustration of the textile material I made by the discharge apparatus 13 shown by FIG. 1. Due to the filament 7 exiting the outlet 9 forming loops 8, the textile material 1 comprises regular filament 7 segments which intersect each other at crossover positions 12 and form circular coils. Depending on the setting of the second temperature, the filament 7 segments may either be materially bonded or not materially bonded at the crossover positions 12.

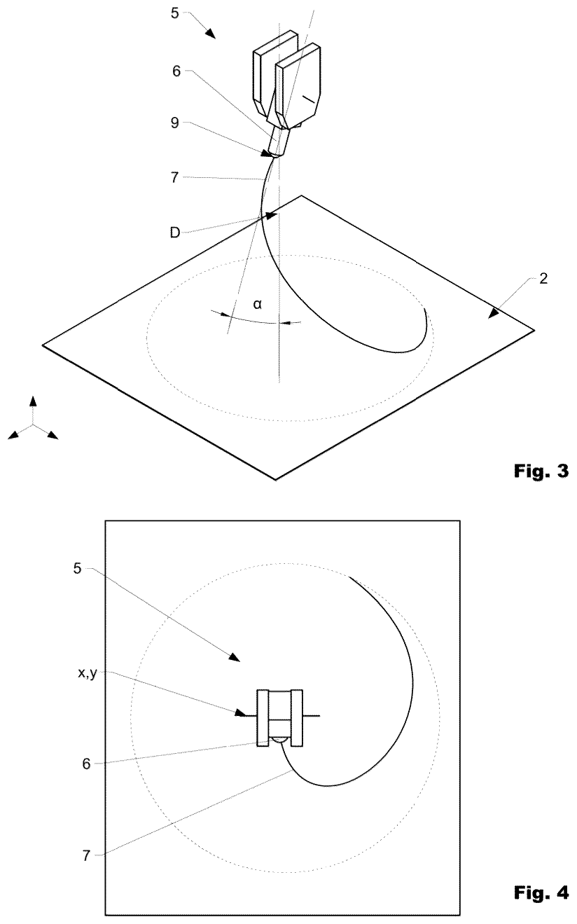

FIG. 3 shows a perspective view from the front and above on a schematic illustration of a first variation of the dosing head 5. FIG. 4 shows a top view on the dosing head 5 according to FIG. 3. The shown nozzle 6 is interconnected to the dosing head 5 which is mounted rotatable about the dispensing axis D. In the shown variation, the nozzle 6 is tiltable with respect to the dispensing axis D about an angle α. This allows to influence the size of the loops. A larger angle leads to larger loops on the shaping carrier 2, a smaller angle subsequently to smaller loops. In some embodiments, the angle α between the dispensing axis D and the outlet 9 and the discharge direction is between 40° and 60°, preferably between 50° and 60°, in particular 55°.

As the nozzle 6 is moved relative to the dispensing axis D, the filament 7 exits the nozzle 6 and is, caused by the relative movement of the nozzle 6, accelerated along the flight path between nozzle 6 and shaping carrier. When the nozzle 6 revolves on a circular path around the dispensing axis D, the resulting centrifugal force accelerates the filament 7 radially away from the circular path of the nozzle 6 and therefore away from the dispensing axis D. The at least one nozzle 6 may be dynamically is pivoted about an axis with respect to the dispensing axis D. In addition, the shaping carrier can be moved along at least one degree of freedom about an axis. This movement allows to create loops with a more complex geometry.

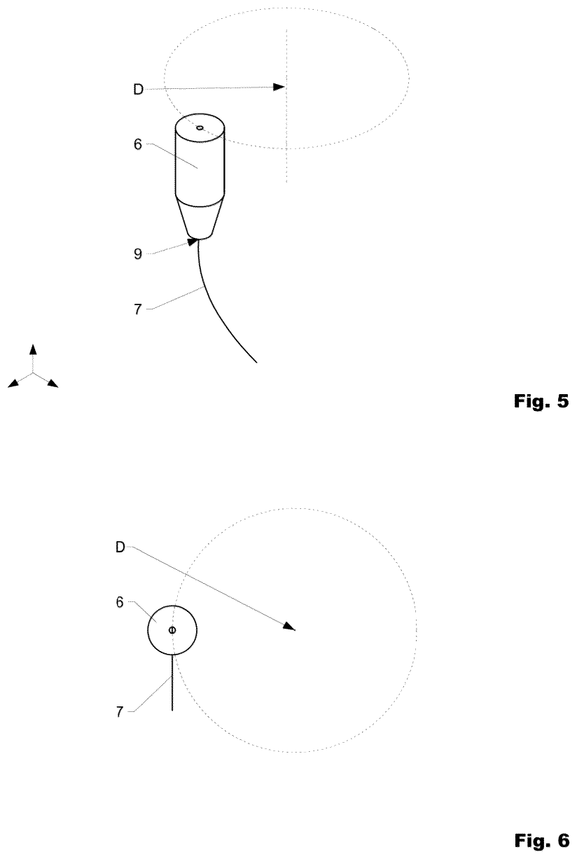

FIG. 5 shows a perspective view from the front and above on a schematic illustration of a second variation of the dosing head. FIG. 6 shows a top view on the dosing head according to FIG. 5. The shown nozzle 6 is interconnected to the dosing head 5 and mounted rotatable about the dispensing axis D with respect to the dosing head. While in the variation shown by FIG. 4 the dosing head as such rotates, here only the nozzle 6 rotates around the dispensing axis D. Due to the rotation, the filament 7 exits the outlet 9 and is accelerated in a radial manner.

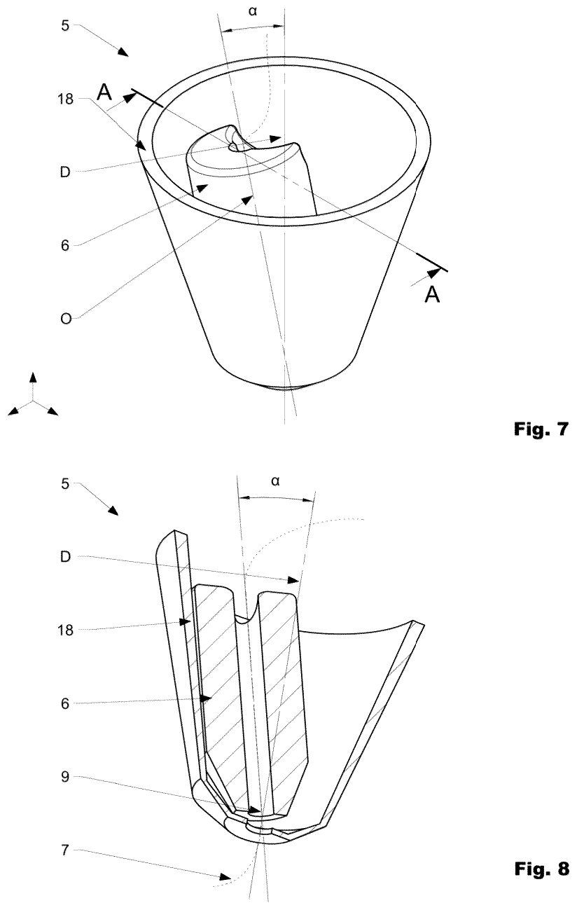

FIG. 7 shows a perspective view from the front and above on a schematic illustration of a third variation of the dosing head 5, with the flow of the melt being indicated by the dotted line. FIG. 8 shows a sectional view (A-A) on the dosing head according to FIG. 7. In the shown variation, the second movement comprises moving the at least one nozzle 6 relative to the dosing head 5. The molten polymer composition exits the at least one nozzle 6 through the outlet 9, in the shown variation in form of an opening of a through bore extending through the nozzle 6 and thereby forming the filament 7. During the application the at least one nozzle 6 is moved relative to the dispensing axis D, by being rotated around the dispensing axis D. This rotation causes the filament 7 to form loops. In the shown variation, the nozzle 6 is moved within a nozzle housing 18. The nozzle 6 is mounted axially rotatable in the nozzle housing 18 and the plasticized and pressurized polymer composition being forced through the nozzle housing 18 causes the rotation of the nozzle 6. The nozzle 6 extends along an outlet axis O, which is aligned at an inclined angle α with respect to the dispensing axis D.

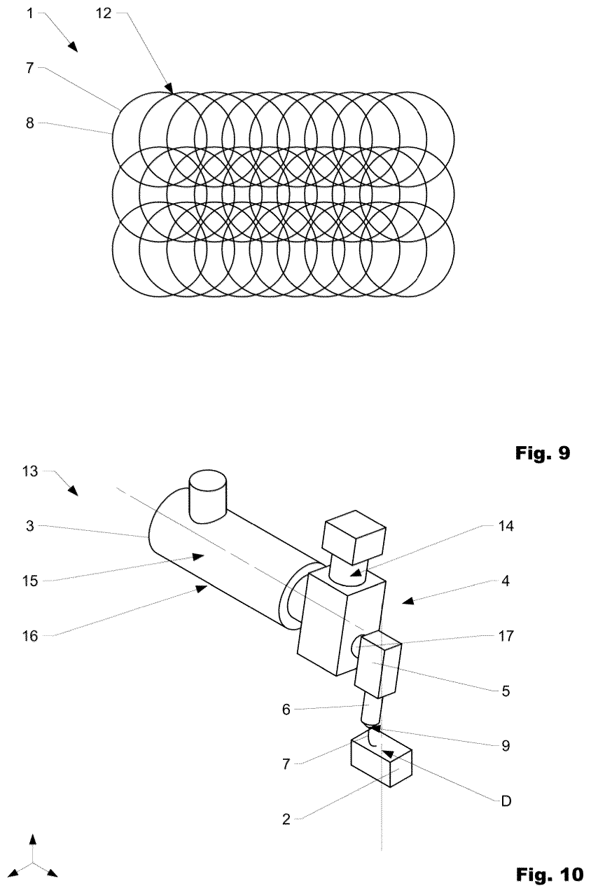

FIG. 9 shows a schematic illustration of a textile material I made by a dosing head shown by any of FIGS. 3 to 8. Due to the filament 7 exiting the outlet, forming loops 8, the textile material 1 comprises regular filament 7 segments which intersect each other at crossover positions 12 and form circular coils. The setting of the second temperature can have an influence whether the filament 7 segments either materially bond or do not bond at the crossover positions 12. Due to the circular motion of the nozzle and/or the dosing head, the resulting loops 8 are essentially circular as well.

FIG. 10 shows a perspective view from the front and above on a schematic illustration of a second variation of the discharge apparatus 13 with a swivelling dosing head 5 for applying the filament 7. The shown discharge apparatus 13 comprises a dosing head 5, which is in fluid communication with a plasticizing unit 3 and with a separate dosing pump 14. The plasticizing unit 3 comprises an extruder 15, which typically has a drum 16, and a screw (not shown) arranged therein. The dosing pump 14 is in fluid communication with the dosing head 5. The dosing head 5 has at least one nozzle 6 comprising an outlet 9, which is in fluid communication with the dosing head 5. The shown plasticizing unit 3 includes a plurality of, in particular three, consecutively arranged temperature zones. Each temperature zone includes a separately controllable heating element. The shown depositing unit 4 comprises a dosing head holder 17 to which the dosing head 5 is connected and wherein the second movement comprises moving the dosing head 5 and the at least one nozzle 6 together relative to the dosing head holder 17. The shown dosing head 5 is mounted pivotable to allow a swivelling motion of the nozzle 6 with respect to the dispensing axis D and the shaping carrier 2.

FIG. 11 shows a perspective view from the back on a schematic illustration of the discharge apparatus 13 according to FIG. 10 with a swiveling nozzle 6 in three positions. FIG. 9b shows the discharge apparatus 13 in a neutral position with the nozzle being aligned with the dispensing axis D. In FIGS. 9a and FIG. 9c, the nozzle is displaced to the extreme points. In operation the dosing head 5 swivels between the two extreme points. Due to the distance D between outlet and shaping carrier 2 and the dynamic motion of the dosing head 5, the filament is laterally accelerated. If the shaping carrier 2 is in addition moved perpendicular to the motion of the dosing head 5, sinuous shaped loops form on the shaping carrier.

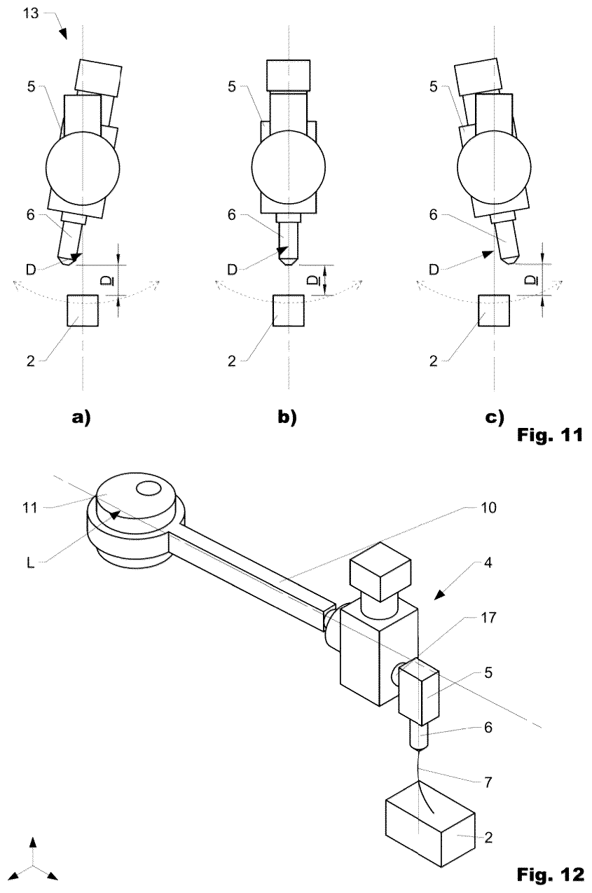

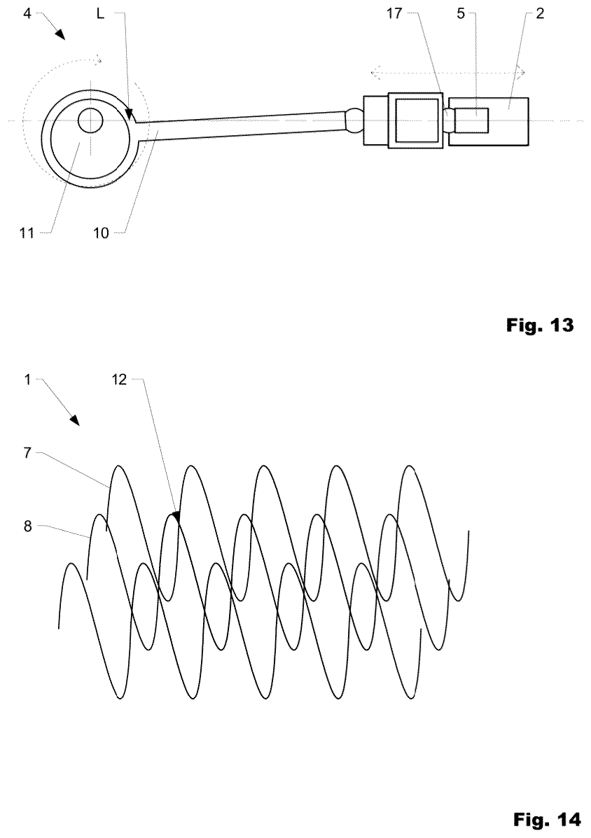

FIG. 12 shows a perspective view from the front and above on a schematic illustration of a fourth variation of the dosing head 5 with an eccentric drive. FIG. 13 shows a top view on the dosing head 5 according to FIG. 12. The shown discharge apparatus 13 comprises a dosing head 5, which is in fluid communication with a plasticizing unit, which is not shown in this variation. The dosing head 5 has at least one nozzle 6 comprising an outlet 9, which is in fluid communication with the dosing head 5. The shown dosing head 5 is interconnected to the depositing unit by a dosing head holder 17. The dosing head holder 17 connects the dosing head 5 to the depositing unit 4 in a movable manner. The shown dosing head 5 is connected via an eccentric rod to an eccentric to create a lateral back and forth movement of the dosing head 5 along a longitudinal axis L. With the eccentric a rotational movement of a motor is converted into a translational movement of the dosing head 5. With the eccentric the at least one nozzle is moved back and forth and thereby the filament 7 is applied to the shaping carrier 2.

FIG. 14 shows a schematic illustration of a textile material 1 made by a dosing head 5 shown by FIGS. 10 and 11 or the dosing head 5 shown by FIGS. 12 and 13. The shown textile material 1 comprises regular filament 7 segments, which intersect each other at crossover positions 12 and form a regular pattern. Because of the back-and-forth movement, respectively the swiveling movement, the filament forms a snake pattern on the shaping carrier 2 with a sinusoidal shape.

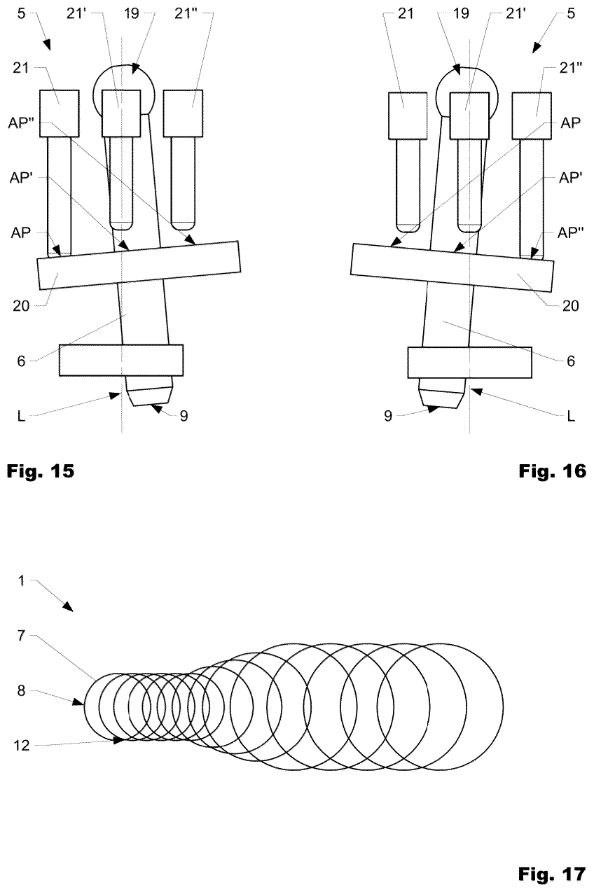

FIGS. 15 and 16 show a first lateral view (FIG. 15) and a second lateral view (FIG. 16) on a schematic illustration of a fifth variation of the dosing head 5 with a swiveling nozzle 6. The nozzle 6 is arranged in a swiveling and rotatable manner, via a ball joint 19. The swiveling motion is achieved by the shown disk 20 which is attached to the nozzle 6 and projects radially away from the nozzle 6. The disk 20 is moved by the shown actuating elements 21, 21′, 21″. Each of the actuating elements 21, 21′, 21″ is configured to engage the disk 20 at different actuation points AP, AP′, AP″. The actuating elements 21, 21′, 21″ enable the movement of the nozzle 6 and thereby the outlet 9, approximating in a circular path. The actuating elements 21, 21′, 21″, 21″′ and the application points AP, AP′, AP″ are arranged at constant angular distances from each other with respect to a longitudinal axis L, so that a high degree of symmetry is provided.

FIG. 17 shows a schematic illustration of a textile material made by a dosing head 5 shown by FIGS. 15 and 16. Due to the filament 7 exiting the outlet, forming loops 8, the textile material 1 comprises regular filament 7 segments which intersect each other at crossover positions 12 and form circular coils. Due to the circular motion of the nozzle and/or the dosing head, the resulting loops 8 are essentially circular as well. This variation has the advantage that the eccentricity of the outlet can be changed continuously and quickly with the appropriate design and control of the dosing head leading to loops 8 with a varying diameter. In addition, the application is not necessarily circular, but can assume other shapes by appropriate control of the dosing head. The dosing head can be kept still regarding the longitudinal axis so that the material can be applied in a thin, straight line.

Rather, the words used in the specification are words of description rather than limitation, and it is understood that various changes may be made without departing from the spirit and scope of the disclosure.

1. A method for producing a textile material (1) comprising the steps:
a. providing a shaping carrier (2);
b. providing a plasticizing unit (3) for melting a polymer composition at a first temperature to provide a molten polymer composition;
c. providing a depositing unit (4) comprising a dosing head (5) which comprises at least one nozzle (6);
d. applying the molten polymer composition via the at least one nozzle (6) on the shaping carrier (2) in form of a filament (7) forming a plurality of loops (8) on the shaping carrier (2);
wherein during step d. the depositing unit (4) and/or the shaping carrier (2) are in a first movement moved relative to each other such that the at least one nozzle (6) moves along a drive path which runs on the shaping carrier (2); and
wherein during forming each loop (8) the dosing head (5) and/or the at least one nozzle (6) and/or the shaping carrier (2) is additionally moved in a second movement being different from the first movement along a loop depositing path with a path length such that the length of each loop (8) formed on the carrier is larger than the path length of the depositing path.

2. The method according to claim 1, wherein the depositing path is different from the drive path, wherein a path length of the drive path along which the at least one nozzle (6) moves during the formation of each loop is shorter than the path length of the depositing path during formation of each loop.

3. The method according to claim 1, wherein in the second movement the at least one nozzle (6), and/or the dosing head (5) and the at least one nozzle (6) are moved in at least one of a round, circular, oval, eccentric, and a pendulum movement.

4. The method according to claim 1, wherein the second movement comprises moving the at least one nozzle (6) relative to the dosing head (5).

5. The method according to claim 4, wherein the molten polymer composition exits the at least one nozzle (6) through an outlet (9) forming the filament (7) and during the application the at least one nozzle (6) is moved relative to a dispensing axis (D) such that the filament forms loops (8).

6. The method according to claim 4, wherein the nozzle (6) is moved within a nozzle housing (18) axially rotatably mounted therein and which is caused to rotate by the plasticized polymer composition flowing through the nozzle housing (18).

7. The method according to claim 6, wherein the nozzle (6) extends along an outlet axis (O) which is aligned at an angle (α) with respect to the dispensing axis (D).

8. The method according to claim 1, wherein the depositing unit (4) comprises a dosing head holder (17) to which the dosing head (5) is connected and wherein the second movement comprises moving the dosing head (5) and the at least one nozzle (6) together relative to the dosing head holder (17).

9. The method according to claim 8, wherein the molten polymer composition exits the at least one nozzle (6) through the outlet (9) forming the filament (7) and during the application the dosing head (5) and the at least one nozzle (6) are together moved relative to the dosing head holder (17) about the dispensing axis (D) such that the filament forms loops (8).

10. The method according to claim 8, wherein the at least one nozzle (6) is tilted with respect to the dosing head (5) about an angle (α).

11. The method according to claim 8, wherein the dosing head (5) is interconnected to an eccentric rod (10) which is interconnected to an eccentric (11) to create a lateral back and forth movement along a longitudinal axis (L).

12. The method according to claim 1, wherein during the application the shaping carrier (2) is spaced a distance (D) from the at least one nozzle (6) and the shape of the formed loops (8) corresponds to a movement pattern of the at least one nozzle being defined by the first movement and second movement in an enlarged scale.

13. The method according to claim 1, wherein the distance (D) between the at least one nozzle (6) and the shaping carrier (2) is between 20 mm and 110 mm, in particular between 40 mm to 60 mm.

14. The method according to claim 1, wherein the filament (7) has a filament thickness in the range of 0.01 mm to 0.3 mm, in particular from 0.05 mm to 0.2 mm.

15. The method according to claim 1, wherein the shaping carrier (2) is moved relative to the dosing head (5) and the at least one nozzle (6) at a speed of 1 m/min to 20 m/min, in particular 5 m/min to 15 m/min or vice versa.

16. The method according to claim 1, wherein the polymer composition is applied as a continuous filament (7) to the shaping carrier (2) so as to form a textile segment and/or wherein the polymer composition is applied as a discontinuous filament (7) so as to form a nonwoven-like textile segment.

17. The method according to claim 1, wherein the polymer composition has an adjustable second temperature during application, which is either selected such that the filament applied to the shaping carrier (2) does not bond at crossover positions (12) of filament (7) segments, or that the second temperature is selected such that the filament (7) applied to the shaping carrier (2) bonds at crossover positions (12) of filament segments (7) by fusion.

18. The method according to claim 1, wherein the polymer composition comprises at least one of a thermoplastic polymer, polyamide, polyether block amide, polyurethane, and polyester.

19. The method according to claim 1, wherein the fabricated textile material is a shoe upper and is bonded to a sole, or wherein the shoe upper is bonded directly to a sole during application.

20. The method according to claim 1, wherein the movement of the shaping carrier (2) and/or the dosing head (5) with the at least one nozzle (6) is controlled by a control unit.

21. A shoe comprising the textile material produced by the method according to claim 1.

22. The method according to claim 1 wherein the textile material (1) comprises a shoe upper and the shaping carrier (2) comprises a last.

23. The method according to claim 5, wherein the at least one nozzle (6) is rotated around a dispensing axis (D) such that the filament forms loops (8).
